(19) United States
(12) Patent Application Publication
(10) Pub. No.: US 2017/0129077 A1
(43) Pub. Date: May 11, 2017

(54) Extension Element for Improved Use of An Adjustable Wrench

(71) Applicant: Thru Tubing Solutions, Inc., Oklahoma City, OK (US)

(72) Inventors: Brock Watson, Oklahoma City, OK (US); Roger Schultz, Newcastle, OK (US); Greg A. Kliewer, Edmond, OK (US); Andy Ferguson, Moore, OK (US)

(73) Assignee: Thru Tubing Solutions, Inc.

(21) Appl. No.: 15/295,798

(22) Filed: Oct. 17, 2016

Related U.S. Application Data
(63) Continuation of application No. 15/127,344.
(60) Provisional application No. 61/981,284, filed on Apr. 18, 2014.

(51) Int. Cl. B25B 13/50

(52) U.S. Cl. CPC B25B 13/5058

(57) ABSTRACT

This disclosure is related to an adjustable wrench for engaging work objects. The adjustable wrench has a handle having a handle end and a flat serrated jaw surface. The adjustable wrench also has an L-shaped movable jaw having a lever arm and a serrated jaw, the lever arm having a terminal end and an extension element extending from the terminal end having an opening therethrough. The adjustable wrench further comprises a projection extending from the handle having a tunnel therein for accepting the lever arm of the L-shaped movable jaw and a grip enhancing apparatus.

### CROSS-REFERENCE TO RELATED APPLICATIONS

The present application is a continuation of U.S. Ser. No. 15/127,344, filed Sep. 19, 2016, which is a U.S. National Stage filing of International application Ser. No. PCT/US2015/026715, filed Apr. 20, 2015, which is a conversion of U.S. Ser. No. 61/981,284, filed Apr. 18, 2014, which claims the benefit under 35 U.S.C. 119(e), the disclosures of which are hereby expressly incorporated herein by reference.

### STATEMENT REGARDING FEDERALLY SPONSORED RESEARCH OR DEVELOPMENT

Not applicable.

### BACKGROUND OF THE DISCLOSURE

Field of the Invention

The present disclosure relates to an adjustable wrench that includes an extension device to permit better performance of a grip enhancing apparatus used with the adjustable wrench to better engage a work object.

Description of the Related Art

Traditionally, pipe wrenches are adjustable wrenches used for fitting and turning rounded surfaces. A user manipulates the wrench to fit the rounded surface and then must apply pressure to the wrench to engage the rounded surface and turn it. If a user does not continue to apply force to the wrench, the wrench will not stay engaged on the rounded surface and would fall to the ground if the user does not hold it. Accordingly, there is a need for a wrench that can stay engaged on a rounded surface without the user having to hold the wrench and continually apply pressure to the wrench.

### SUMMARY OF THE DISCLOSURE

The present disclosure is directed to an adjustable wrench for engaging a work object. The wrench includes a handle having a handle end and a flat serrated jaw surface. The wrench also includes an L-shaped movable jaw having a lever arm and a serrated jaw, the lever arm having a terminal end with an extension device extending therefrom and an opening in the extension device. The wrench further includes a projection extending from the handle having a tunnel therein for accepting the lever arm of the L-shaped movable jaw. Additionally, the wrench includes a grip enhancing apparatus. The grip enhancing apparatus can have numerous designs. In one embodiment, the grip enhancing apparatus includes a threaded nut element disposed adjacent to the extension device, the threaded nut element having a threaded opening therein. The grip enhancing apparatus also includes a threaded shaft for extending through the opening of the extension device and engaging the threaded opening of the threaded nut element. The threaded shaft can extend through the threaded nut element and contact the handle of the adjustable wrench, forcing the L-shaped movable jaw away from the handle and the serrated jaw of the L-shaped movable jaw is forced toward the flat serrated jaw surface.

The present disclosure is directed to an adjustable wrench for engaging a work object. The wrench includes an opening, a handle having a handle end and a flat serrated jaw surface. The wrench also includes an L-shaped movable jaw having a lever arm and a serrated jaw, the lever arm having a terminal end. The wrench further includes a projection extending from the handle having a tunnel therein for accepting the lever arm of the L-shaped movable jaw. Additionally, the wrench includes a grip enhancing apparatus. The grip enhancing apparatus includes a threaded nut element disposed adjacent to the lever arm, the threaded nut element having a threaded opening therein. The grip enhancing apparatus also includes a threaded shaft for extending through the opening of the handle and engaging the threaded opening of the threaded nut element. The threaded shaft can extend through the threaded nut element and contact the lever arm of the adjustable wrench, forcing the L-shaped movable jaw away from the handle and the serrated jaw of the L-shaped movable jaw is forced toward the flat serrated jaw surface.

The present disclosure is related to another adjustable wrench. The adjustable wrench includes a handle having a handle end and a flat serrated jaw surface, a projection extending from the handle having a tunnel therein for accepting the lever arm of the L-shaped movable jaw, and a grip enhancing apparatus. The grip enhancing apparatus having a cam device supported by the lever arm, the cam device having an outer perimeter wherein a portion of the outer perimeter is defined by an increased radius of the cam device.

The present disclosure is related to another embodiment of an adjustable wrench. The adjustable wrench includes a handle having a handle end and a flat serrated jaw surface, a projection extending from the handle having a tunnel therein for accepting the lever arm of the L-shaped movable jaw, and a grip enhancing apparatus. The grip enhancing apparatus having a wedge device slidably disposed on the handle, wherein the wedge device can slide between the lever arm and the handle. The grip enhancing apparatus also includes a protrusion extending from the handle having a threaded passageway therein. The grip enhancing apparatus further includes a rod with a threaded portion for engaging the threaded passageway of the protrusion.

The present disclosure is related to yet another embodiment of an adjustable wrench. The adjustable wrench includes a handle having a handle end and a flat serrated jaw surface, a projection extending from the handle having a tunnel therein for accepting the lever arm of the L-shaped movable jaw, and a grip enhancing apparatus. The grip enhancing apparatus having a tubular element to frictionally engage at least the lever arm and force the lever arm away from the handle.

The present disclosure is also related to a grip enhancing apparatus for use with an adjustable wrench. The grip enhancing apparatus includes a wedge element partially disposable between the handle of the wrench and the lever arm, the wedge element having a threaded passageway therein. The grip enhancing apparatus also includes a rod with a threaded portion for engaging the threaded passageway of the wedge element.

### BRIEF DESCRIPTION OF THE DRAWINGS

FIG. 1 is a perspective view of an adjustable wrench with an extension element and grip enhancing apparatus constructed in accordance with the present disclosure.

FIG. 2 is a cross-sectional view of another embodiment of the adjustable wrench with the extension element and grip enhancing apparatus constructed in accordance with the present disclosure.

FIG. 3 is a perspective view of another embodiment of the adjustable wrench with the extension element and grip enhancing apparatus constructed in accordance with the present disclosure.

FIG. 4 is a cross-sectional view of another embodiment of the adjustable wrench with the extension element and grip enhancing apparatus constructed in accordance with the present disclosure.

FIG. 5 is a perspective view of another embodiment of the adjustable wrench with the extension element and grip enhancing apparatus constructed in accordance with the present disclosure.

FIG. 6 is a cross-sectional view of another embodiment of the adjustable wrench with the extension element and grip enhancing apparatus constructed in accordance with the present disclosure.

FIG. 7 is a perspective view of another embodiment of the adjustable wrench with the extension element and grip enhancing apparatus constructed in accordance with the present disclosure.

FIG. 8 is a perspective view of another embodiment of the adjustable wrench with the extension element and grip enhancing apparatus constructed in accordance with the present disclosure.

FIG. 9 is a perspective view of another embodiment of the adjustable wrench with the extension element and grip enhancing apparatus constructed in accordance with the present disclosure.

FIG. 10 is a perspective view of another embodiment of the adjustable wrench with the extension element and grip enhancing apparatus constructed in accordance with the present disclosure.

FIG. 11 is a perspective view of another embodiment of the adjustable wrench with the extension element and grip enhancing apparatus constructed in accordance with the present disclosure.

FIG. 12 is a perspective view of another embodiment of the adjustable wrench with the extension element and grip enhancing apparatus constructed in accordance with the present disclosure.

FIG. 13 is a perspective view of another embodiment of the adjustable wrench with the extension element and grip enhancing apparatus constructed in accordance with the present disclosure.

### DETAILED DESCRIPTION OF THE DISCLOSURE

The present disclosure relates to an adjustable wrench 110 that includes a grip enhancing apparatus 112 to more efficiently engage a work object 114. The work object 114 can be anything capable of having the adjustable wrench 110 used thereon. In one embodiment, the adjustable wrench 110 can be any type of pipe wrench known in the art.

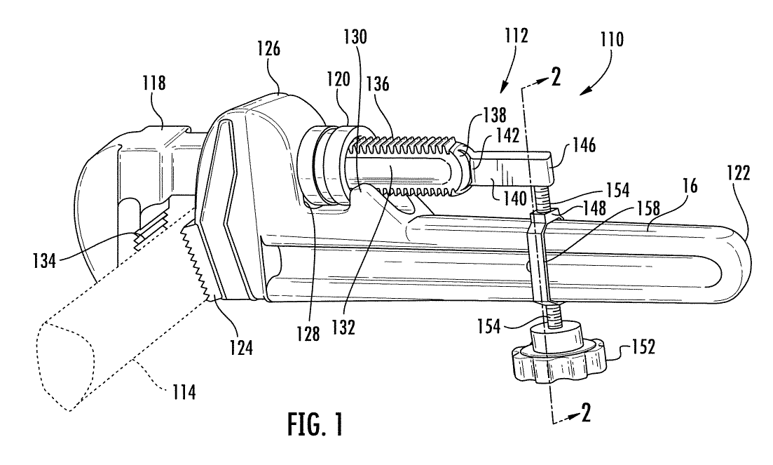

As shown in FIG. 1, an adjustable wrench 110 can include a handle 116, an L-shaped movable jaw 18 and an adjustment nut 120 for positioning the L-shaped movable jaw 118 (or hook jaw) respective of the handle 116. The handle 116 has a handle end 122, a flat serrated jaw surface 124 for engaging the work object 114, and a first projection 126 disposed on the handle 16 adjacent to the flat serrated jaw surface 124. The first projection 126 includes an adaptively-sized tunnel 128 disposed therethrough. The handle 116 can also include a second projection 130 disposed on the handle 16 that cooperates with the first projection 126 to hold and maintain the adjustment nut 120 therebetween.

The L-shaped movable jaw 118 has a lever arm 132 and a serrated jaw 134 for further engagement of the work object 114. The lever arm 132 includes threads 136 that engage the adjustment nut 120 and a terminal end 138 disposed at the opposite end of the L-shaped movable jaw 118 from the serrated jaw 134. Furthermore, the lever arm 132 of the L-shaped movable jaw 118 can be positioned within the tunnel 128 of the first projection 126 of the handle 116. The second projection 130 of the handle 116 is sized such that it does not interfere with the lever arm 132 of the L-shaped movable jaw 118 as it extends through the tunnel 128.

In various embodiments, shown in FIGS. 1-13, the adjustable wrench 110 can also include an extension element 140 supported on a first end 142 by the terminal end 138 of the lever arm 132 of the L-shaped movable jaw 118. The handle 116 also includes a passageway 144 that cooperates with a second end 146 of the extension element 140 and the grip enhancing apparatus 112 to facilitate more efficient engagement of the work object 114.

The extension element 140 can be sized and shaped in any manner such that the grip enhancing apparatus 112 can work with the wrench 110 so that sufficient gripping force can be applied to the work object 114 so that a user is not needed to maintain the wrench 110 in engagement with the work object 114 and not interfere with the traditional operation of the wrench 112. The extension element 140 can be made of any material known in the art capable of withstanding the forces that may be applied thereto. Examples of materials include, but are not limited to, hard plastic materials, metallic materials, and the like. Furthermore, the extension element 140 can be attached to the terminal end 138 of the lever arm 132 via any manner known in the art. Examples of attachment means include, but are not limited to, bolts, rivets, welded, screws, and the like.

In these embodiments, the grip enhancing apparatus 112 includes a threaded nut element 148, a threaded opening 150 disposed in a portion of the threaded nut element 148, and a threaded shaft 154 to engage the threaded opening 150 of the threaded nut element 148. In another embodiment of the present disclosure, the grip enhancing apparatus 112 can include a turn handle 152 attachable to the threaded shaft 154 or, in certain embodiments, the threaded nut 148. It should be understood that the turn handle 152 can be positioned anywhere on the threaded shaft 154 relative to the handle 16 and the extension element 140 and the turn handle 152 can be any apparatus capable of being grasped by a user and be turned. In these embodiments, the passageway 144 is disposed in the handle 116 whereby the threaded shaft 154 of the grip enhancing apparatus 112 can extend therethrough.

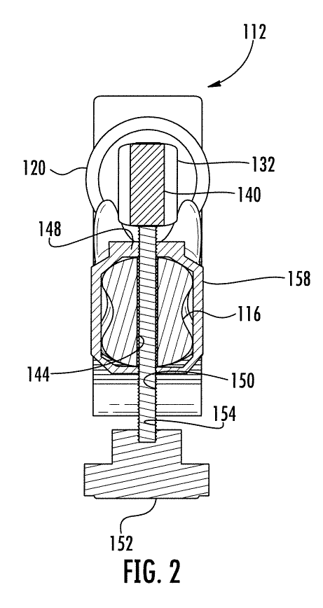

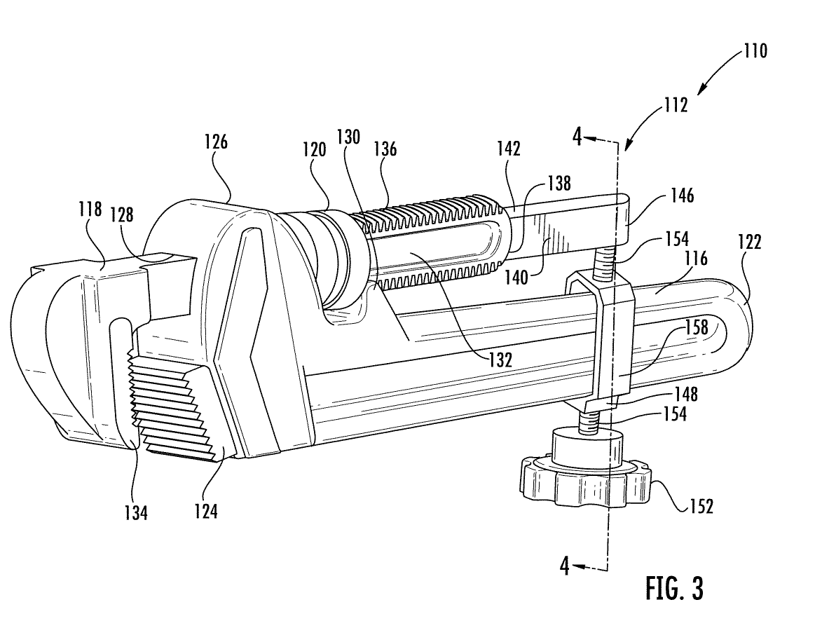

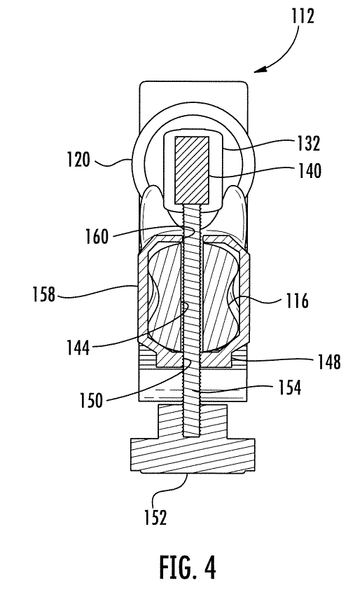

The threaded nut element 148 of the present disclosure can take on a number of shapes and sizes. In two embodiments, shown in FIGS. 1-4, the threaded nut element 148 includes a ring portion 158 attached thereto that extends around the handle 116 to prevent the threaded nut element 148 from turning as the turn handle 152 turns the threaded shaft 154. The ring portion 158 of the threaded nut element 148 includes an opening 160 for permitting the threaded shaft 154 to extend therethrough and generally align with the threaded opening 150 of the threaded nut element 148. In one embodiment, shown in FIGS. 1 and 2, the threaded opening 150 of the threaded nut element 148 is disposed between the second end 146 of the extension element 140 and the handle 116 of the adjustable wrench 110. In another embodiment, shown in FIGS. 3 and 4, the threaded opening 150 of the threaded nut element 148 is disposed on the opposite side of the handle 116 from the second end 146 of the extension element 140.

In use, the threaded shaft 154 of the grip enhancing apparatus 112 extends through the passageway 144 in the handle 116 and the opening 160 in the ring portion 158 of the threaded nut element 148 and engages the threaded opening 150 of the threaded nut element 148. The ring portion 158 of the threaded nut element 148 may contact the handle 116 and prevent the threaded nut element 148 from turning when the threaded opening 150 of the threaded nut element 148 is being engaged by the threaded shaft 154. As the threaded shaft 154 continues to engage the threaded nut element 148, the threaded shaft 154 ultimately contacts the second end 146 of the extension element 140. As the turn handle 152 of the grip enhancing apparatus 112 is turned and continues to force the threaded shaft 154 to engage the second end 146 of the extension element 140, the extension element 140 and the lever arm 132 of the L-shaped movable jaw 118 is forced away from the handle 116 and the serrated jaw 134 of the L-shaped movable jaw 118 is forced toward the flat serrated jaw surface 124 of the handle 116. At a certain point, the work object 114 is securely engaged by the serrated jaw 134 of the L-shaped movable jaw 118 and the flat serrated jaw surface 124 of the handle 116 and the wrench 110 can remain engaged on the work object 114 without a user having to maintain any pressure on the wrench 110 or hold the wrench 110.

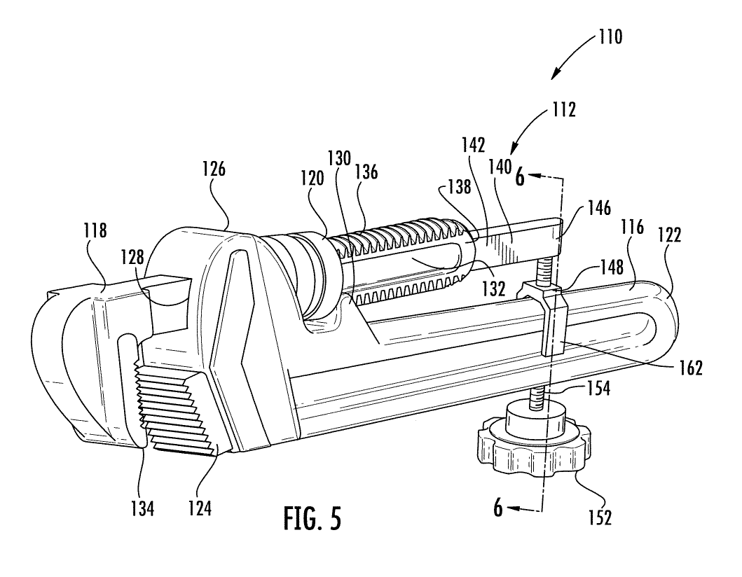

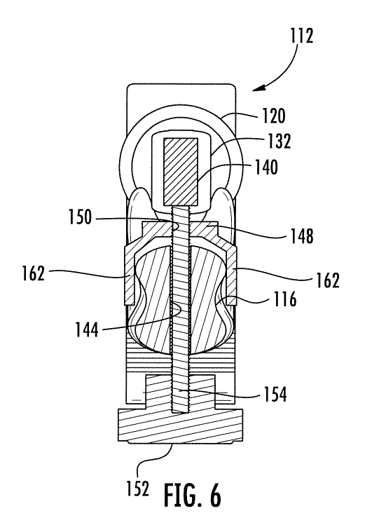

In another embodiment, shown in FIGS. 5 and 6, the threaded nut element 148 includes at least one wing element 162 attached thereto that extends away from the threaded nut element 148 and adjacent to the handle 116 to prevent the threaded nut element 148 from turning as the turn handle 152 turns the threaded shaft 154. In another embodiment, the threaded nut element 148 includes two wing elements 162 extending away from the threaded nut element 148, each wing element 162 disposed adjacent to the handle 116 to prevent the threaded nut element 148 from turning as the turn handle 152 turns the threaded shaft 154. In one embodiment, the threaded opening 150 of the threaded nut element 148 is disposed between the second end 146 of the extension element 140 and the handle 116 of the adjustable wrench 110.

In use, the threaded shaft 154 of the grip enhancing apparatus 112 extends through the passageway 144 in the handle 116 and engages the threaded opening 150 of the threaded nut element 148. The at least one wing element 162 of the threaded nut element 148 may contact the handle 116 and prevent the threaded nut element 148 from turning when the threaded opening 150 of the threaded nut element 148 is being engaged by the threaded shaft 154. As the threaded shaft 154 continues to engage the threaded nut element 148, the threaded shaft 154 ultimately contacts the second end 146 of the extension element 140. As the turn handle 152 of the grip enhancing apparatus 112 is turned and continues to force the threaded shaft 154 to engage the second end 146 of the extension element 140, the extension element 140 and the lever arm 132 of the L-shaped movable jaw 118 is forced away from the handle 116 and the serrated jaw 134 of the L-shaped movable jaw 118 is forced toward the flat serrated jaw surface 124 of the handle 116. At a certain point, the work object 114 is securely engaged by the serrated jaw 134 of the L-shaped movable jaw 118 and the flat serrated jaw surface 124 of the handle 116 and the wrench 110 can remain engaged on the work object 114 without a user having to maintain any pressure on the wrench 110 or hold the wrench 110.

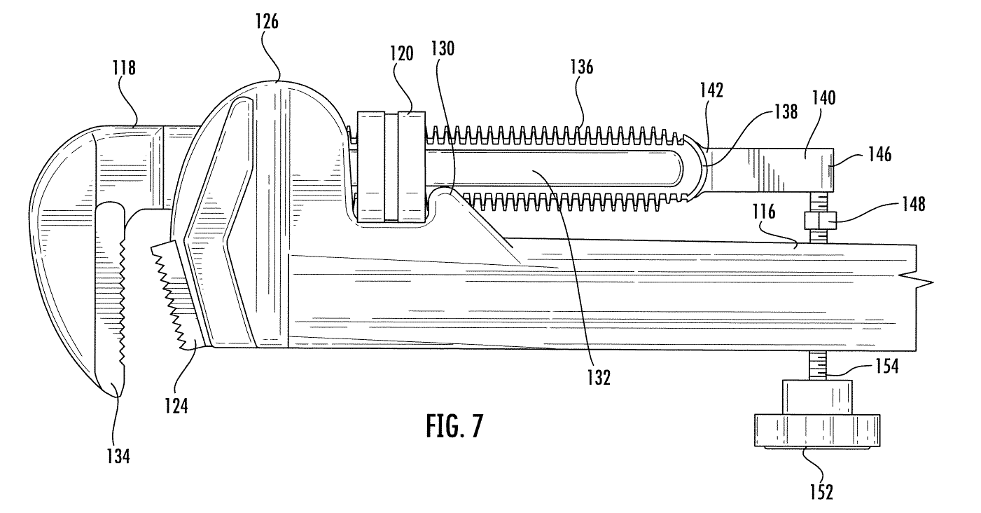

In yet another embodiment, shown in FIG. 7, the threaded nut element 148 is a nut, or a hexagonal nut. The threaded nut element 148 permits the threaded shaft 154 to extend therethrough. The threaded nut element 148 can be disposed between the second end 146 of the extension element 140 and the handle 116 of the adjustable wrench 110. In another embodiment, the turn handle 152 can be attached to the threaded nut 148.

In use, the threaded shaft 154 of the grip enhancing apparatus 112 extends through the passageway 144 in the handle 116 and engages the threaded nut element 148. As the threaded shaft 154 continues to engage the threaded nut element 148, the threaded shaft 154 ultimately contacts the second end 146 of the extension element 140. As the turn handle 152 of the grip enhancing apparatus 112 is turned and continues to force the threaded shaft 154 to engage the second end 146 of the extension element 140, the extension element 140 and the lever arm 132 of the L-shaped movable jaw 118 is forced away from the handle 116 and the serrated jaw 134 of the L-shaped movable jaw 118 is forced toward the flat serrated jaw surface 124 of the handle 116. At a certain point, the work object 114 is securely engaged by the serrated jaw 134 of the L-shaped movable jaw 118 and the flat serrated jaw surface 124 of the handle 116 and the wrench 110 can remain engaged on the work object 114 without a user having to maintain any pressure on the wrench 110 or hold the wrench 110.

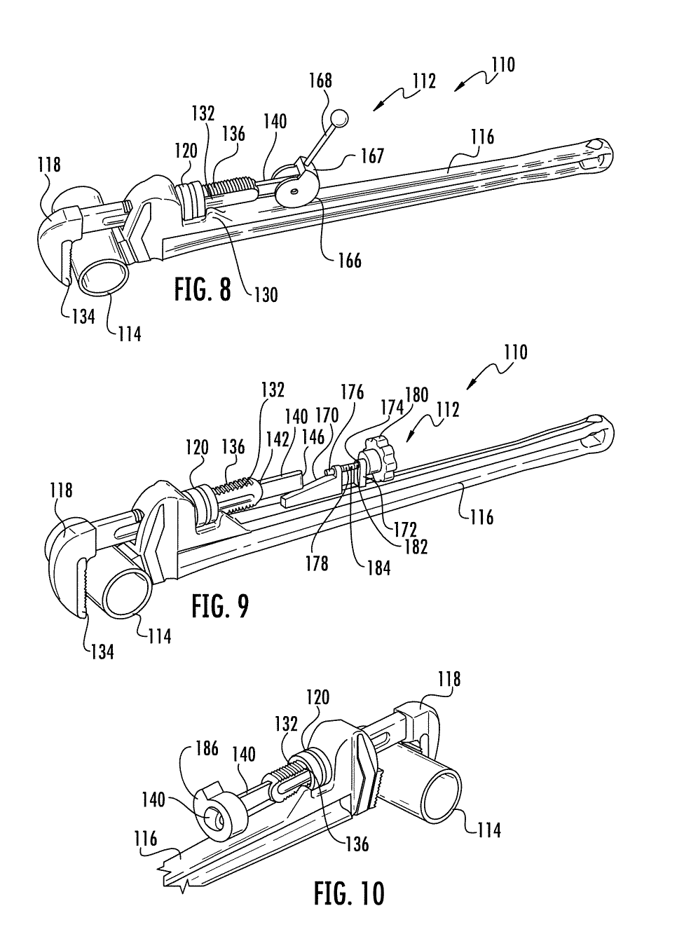

In yet another embodiment of the present disclosure, shown in FIG. 8, the grip enhancing apparatus 112 includes a cam device 166 rotatably supported by the second end 146 of the extension element 140. In this embodiment, the cam device 166 is rotated in a direction that is substantially parallel with the handle 116 of the adjustable wrench 110. The grip enhancing apparatus 112 of this embodiment further includes a leverage element 168 (or any type of handle capable of being attached to the cam device 166 and rotating the cam device 166) attached to the cam device 166 to turn the cam device 166 about the extension element 140. In this embodiment, the cam device 166 has a radius that increases over a portion of an outside perimeter 167 of the cam device 166.

In use, the extension element 140 and the lever arm 132 of the L-shaped movable jaw 118 are forced away from the handle 116 when the leverage element 168 rotates the cam device 166 such that the increased radius is positioned between the extension element 140 and the handle 116. As the leverage element 168 of the grip enhancing apparatus 112 is turned and forces the cam device 166 to engage the extension element 140, the extension element 140 and the lever arm 132 of the L-shaped movable jaw 118 are forced away from the handle 116 and the serrated jaw 134 of the L-shaped movable jaw 118 is forced toward the flat serrated jaw surface 124 of the handle 116. At a certain point, the work object 114 is securely engaged by the serrated jaw 134 of the L-shaped movable jaw 118 and the flat serrated jaw surface 124 of the handle 116 and the wrench 110 can remain engaged on the work object 114 without a user having to maintain any pressure on the wrench 110 or hold the wrench 110.

In yet another embodiment of the present disclosure, shown in FIG. 9, the grip enhancing apparatus 112 includes a wedge device 170 slidably disposed on the handle 116 of the adjustable wrench 110 and under the second end 146 of the extension element 140. In this embodiment, the grip enhancing apparatus 112 also includes a protrusion 172 extending from the handle 116 having a threaded passageway 174 disposed therein. In this embodiment, the wedge device 170 is attached to a first end 176 of a rod 178. In one embodiment, the rod 178 has a turn handle 180 attached to a second end 182 of the rod 178 and a threaded portion 184 for threadably engaging the threaded passageway 174 disposed in the protrusion 172 on the wrench handle 116. It should be understood that the wedge device 170 is not required to be attached to the rod 178. The wedge device 170 could be designed such that the rod 178 contacts it and just pushes the wedge device 170 into the desired position to make the grip enhancing apparatus 112 work properly with the adjustable wrench 110.

In use, the rod 178 is turned and the threaded portion 184 of the rod 178 engages the threaded passageway 174 disposed in the protrusion 172 of the wrench handle 116, the wedge device 170 slides toward the serrated jaw 134 of the L-shaped movable jaw 118 and forces the second end 146 of the extension element 140 away from the handle 116 of the adjustable wrench 110. At a certain point, the work object 114 is securely engaged by the serrated jaw 134 of the L-shaped movable jaw 118 and the flat serrated jaw surface 124 of the handle 116 and the wrench 110 can remain engaged on the work object 114 without a user having to maintain any pressure on the wrench 110 or hold the wrench 110.

In another embodiment shown in FIG. 10, the grip enhancing apparatus 112 includes a cam device 186 that has an increased radius over a portion of the perimeter of the cam device 186 and turns about the extension element 140 in a direction that is substantially perpendicular to the length of the handle 116 of the adjustable wrench 110. The cam device 186 in this embodiment is supported by the extension element 140 and can be rotated around the extension element 140 attached to the lever arm 132.

In use, the extension element 140 is forced away from the handle 116 when the cam device 186 is rotated such that the increased radius portion of the cam device 186 is positioned between the extension element 140 and the handle 116. As the cam device 186 is turned, the increased radius of the cam device 186 forces the cam device 186 to engage the handle 116. This forces the extension element 140 away from the handle 116 and the serrated jaw 134 of the L-shaped movable jaw 118 is forced toward the flat serrated jaw surface 124 of the handle 116. At a certain point, the work object 114 is securely engaged by the serrated jaw 134 of the L-shaped movable jaw 118 and the flat serrated jaw surface 124 of the handle 116 and the wrench 110 can remain engaged on the work object 114 without a user having to maintain any pressure on the wrench 110 or hold the wrench 110.

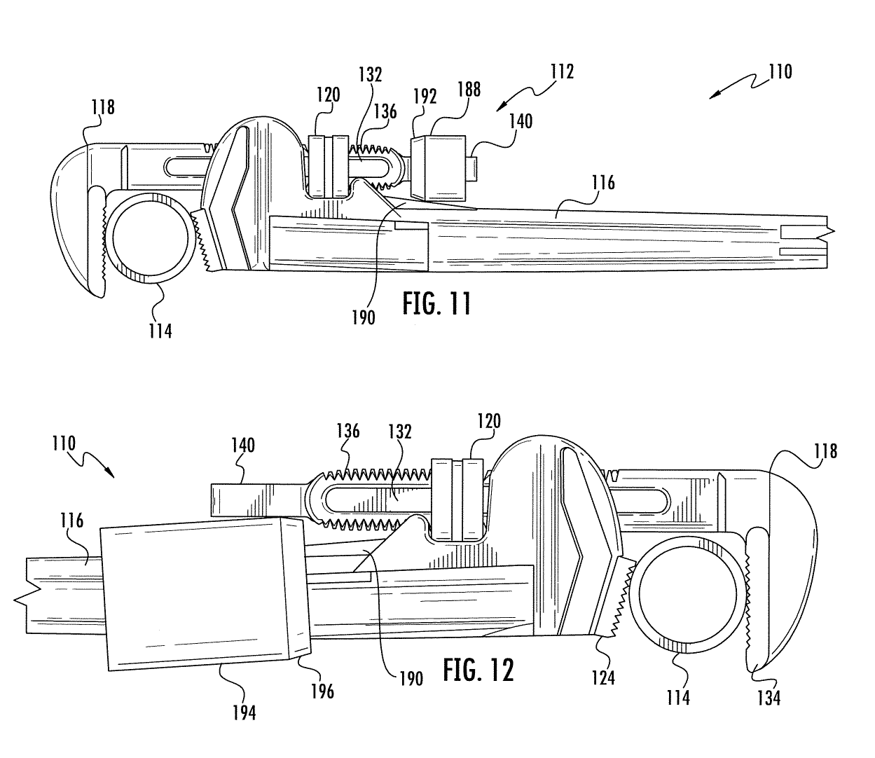

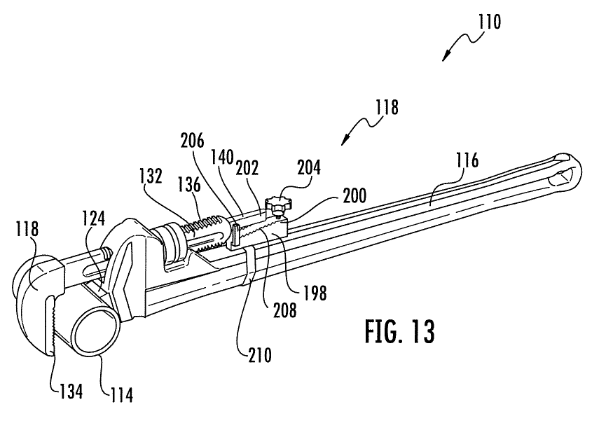

In yet another embodiment of the present disclosure, shown in FIGS. 11 and 12, the grip enhancing apparatus 12 includes a tubular element 188 sized such that it can be disposed around the extension element 140 attached to the lever arm 132. In this embodiment, the handle 116 of the adjustable wrench 110 includes an inclined portion 190 attached to the handle 116 between the extension element 140 and the handle 116. The inclined portion 190 inclines in the direction from the handle end 122 to the flat serrated jaw surface 124. In another embodiment, the tubular element 188 includes a tapered portion 192 disposed about at least a portion of the circumference of one end of the tubular element 188.

In use, the tubular element 188 can be forced by hand over the second end 146 of the extension element 140 to frictionally engage with at least the inclined portion 190 of the handle 116 and/or the extension element 140. This would force the extension element 140 attached to the lever arm 132 to be forced away from the handle 116 of the adjustable wrench 110, which would force the serrated jaw 134 of the L-shaped movable jaw 118 toward the flat serrated jaw surface 124 of the handle 116. This enables the adjustable wrench 110 to grip a work object 114 without a user having to continually apply force to the adjustable wrench 110 or hold the adjustable wrench 110 in place. In another embodiment, the terminal end 138 of the lever arm 132 is threaded and the tubular element 188 is threaded. In this embodiment, the user would screw the tubular element 188 in place such that the tapered portion 192 engages the inclined portion 190 of the wrench handle 116, as described above.

In yet another embodiment, shown in FIG. 12, the grip enhancing apparatus 112 includes a tubular element 194 sized such that it can be disposed around the handle 116 of the adjustable wrench 110. In this embodiment, the handle 116 of the adjustable wrench 110 includes the inclined portion 190 attached to the handle 116 between the extension element 140 and the handle 116. The inclined portion 190 inclines in the direction from the handle end 122 to the flat serrated jaw surface 124. In another embodiment, the tubular element 194 includes a tapered portion 196 disposed about at least a portion of the circumference of one end of the tubular element 194.

In use, the tubular element 194 can be forced by hand over the handle 116 to frictionally engage with at least the inclined portion 190 of the handle 116 and/or the extension element 140. This would force the extension element 140 attached to the lever arm 132 of the L-shaped movable jaw 118 to be forced away from the handle 116 of the adjustable wrench 110, which would force the serrated jaw 134 of the L-shaped movable jaw 118 toward the flat serrated jaw surface 124 of the handle 116. This enables the adjustable wrench 110 to grip a work object 114 without a user having to continually apply force to the adjustable wrench 110, or hold the adjustable wrench 110 in place.

In another embodiment of the present disclosure, shown in FIG. 13, the grip enhancing apparatus 112 includes a wedge element 198 disposable on the handle 116 of the adjustable wrench 110 and under the extension element 140. In this embodiment, the wedge element 198 also includes a threaded passageway 200 disposed therein. In this embodiment, the grip enhancing apparatus 112 also includes an at least partially threaded rod 202 to engage the threaded passageway 200 disposed in the wedge element 198. In one embodiment, the rod 202 has a turn handle 204 attached thereto. In another embodiment, the wedge element 198 can include a plurality of wing elements 206 that extend from the wedge element 198 and are disposed adjacent to the extension element 140 and/or the handle 116 of the adjustable wrench 110 to prevent the wedge element 198 from turning when the rod 202 is turned. In a further embodiment, the wedge element 198 can include at least one ridge element 208 disposed on a top portion of the wedge element 198 to engage with the extension element 140. The at least one ridge element 208 prevents the wedge element 198 from sliding back when in use.

In another embodiment, the grip enhancing apparatus 112 can include an attachment apparatus 210 for selectively attaching the wedge element 198 to the handle 116 or the extension element 140. Examples include, but are not limited to Velcro®, elastic strap, and the like. It should be understood that the attachment apparatus 210 can be any device known in the art capable of securing the attachment apparatus 210 to the handle 116 or extension element 140 and permits the grip enhancing apparatus 112 to perform its intended function.

In use, the grip enhancing apparatus 112 is placed in the appropriate position relative to the extension element 140 and the handle 116. The threaded rod 202 is then turned and engages the threaded passageway 200 disposed in the wedge element 198. As the rod 202 is turned through the threaded passageway 200, the rod 202 will ultimately contact the handle 116, which raises the wedge element 198 off of the handle 116 and forces the wedge element 198 into the extension element 140. This forces the extension element 140 attached to the lever arm 132 of the L-shaped movable jaw 118 away from the handle 116 of the adjustable wrench 110. At a certain point, the work object 114 is securely engaged by the serrated jaw 134 of the L-shaped movable jaw 118 and the flat serrated jaw surface 124 of the handle 116 and the wrench 110 can remain engaged on the work object 114 without a user having to maintain any pressure on the wrench 110 or hold the wrench 110.

From the above description, it is clear that the present disclosure is well adapted to carry out the objectives and to attain the advantages mentioned herein as well as those inherent in the disclosure. While presently disclosed embodiments have been described for purposes of this disclosure, it will be understood that numerous changes may be made which will readily suggest themselves to those skilled in the art and which are accomplished within the spirit of the disclosure.

What is claimed is:

1. An adjustable wrench for engaging a work object, the wrench comprising:
a handle having a handle end and a flat serrated jaw surface;
an L-shaped movable jaw having a lever arm and a serrated jaw, the lever arm having a terminal end;
a projection extending from the handle having a tunnel therein for accepting the lever arm of the L-shaped movable jaw;
an extension element extending from the terminal end of the lever arm; and
a grip enhancing apparatus, the grip enhancing apparatus comprising:
a cam device supported by the extension element, the cam device having an outer perimeter wherein a portion of the outer perimeter is defined by an increased radius of the cam device.

2. The wrench of claim 1 wherein the cam device rotates in a direction that is substantially parallel with the handle.

3. The wrench of claim 1 wherein the cam device rotates in a direction that is substantially perpendicular to the length of the handle.

4. The wrench of claim 1 wherein the radius of the cam device gradually increases over a portion of the outer perimeter of the cam device.

5. The wrench of claim 1 wherein the grip enhancing apparatus further includes a leverage element attached to the cam device.

6. An adjustable wrench for engaging a work object, the wrench comprising:
a handle having a handle end and a flat serrated jaw surface;
an L-shaped movable jaw having a lever arm and a serrated jaw, the lever arm having a terminal end;
a projection extending from the handle having a tunnel therein for accepting the lever arm of the L-shaped movable jaw;
an extension element extending from the terminal end of the lever arm; and
a grip enhancing apparatus, the grip enhancing apparatus comprising:
a wedge device slidably disposed on the handle, wherein the wedge device can slide between the extension element and the handle;
a protrusion extending from the handle having a threaded passageway therein; and
a rod with a threaded portion for engaging the threaded passageway of the protrusion.

7. The wrench of claim 6 wherein the wedge device is attached to one end of the rod.

8. The wrench of claim 7 wherein a turn handle is attached to the rod.

9. An adjustable wrench for engaging a work object, the wrench comprising:
a handle having a handle end and a flat serrated jaw surface;
an L-shaped movable jaw having a lever arm and a serrated jaw, the lever arm having a terminal end;
a projection extending from the handle having a tunnel therein for accepting the lever arm of the L-shaped movable jaw;
an extension element extending from the terminal end of the lever arm; and
a grip enhancing apparatus, the grip enhancing apparatus comprising:
a tubular element to frictionally engage at least the lever arm and force the lever arm away from the handle.

10. The wrench of claim 9 wherein the handle has an inclined portion opposite of the extension element.

11. The wrench of claim 9 wherein the tubular element has a tapered portion disposed about at least a portion of a circumference of one end of the tubular element.

12. The wrench of claim 9 wherein the tubular element is sized to fit over the extension element.

13. The wrench of claim 9 wherein the tubular element is sized to fit over the handle.

14. An adjustable wrench for engaging a work object, the wrench comprising:
a handle having a handle end and a flat serrated jaw surface;
an L-shaped movable jaw having a lever arm and a serrated jaw, the lever arm having threads and a terminal end;
a projection extending from the handle having a tunnel therein for accepting the lever arm of the L-shaped movable jaw;
an extension element extending from the terminal end of the lever arm; and
a grip enhancing apparatus, the grip enhancing apparatus comprising:
a wedge element at least partially disposable between the handle and the extension element, the wedge element having a threaded passageway therein; and
a rod with a threaded portion for engaging the threaded passageway of the wedge element.

15. The wrench of claim 14 wherein the wedge element has at least one wing element attached thereto which extends away from the wedge element and is positioned adjacent to the extension element or the wrench handle.

16. The wrench of claim 14 wherein the wedge element has a plurality of wing elements attached thereto which extend away from the wedge element and are positioned adjacent to the extension element or the wrench handle.

17. The wrench of claim 14 wherein the grip enhancing apparatus further includes an attachment apparatus to selectively attach the wedge element to the handle or the extension element.

18. The wrench of claim 14 wherein the rod has a turn handle attached thereto.

19. A grip enhancing apparatus for an adjustable wrench to facilitate the engagement of a work object, the adjustable wrench having a handle, a flat serrated jaw surface, an L-shaped movable jaw having a lever arm, the lever arm having an extension element extending therefrom, and a serrated jaw, the grip enhancing apparatus comprising:
a wedge element partially disposable between the handle of the wrench and the extension element, the wedge element having a threaded passageway therein; and
a rod with a threaded portion for engaging the threaded passageway of the wedge element.

20. The apparatus of claim 19 wherein the wedge element has at least one wing element attached thereto which extends away from the wedge element and is positioned adjacent to the extension element or the wrench handle.

21. The apparatus of claim 19 wherein the wedge element has a plurality of wing elements attached thereto which extend away from the wedge element and are positioned adjacent to the extension element or the wrench handle.

22. The apparatus of claim 19 wherein the grip enhancing apparatus further includes an attachment apparatus to selectively attach the wedge element to the handle or extension element.

23. The apparatus of claim 19 wherein the rod has a turn handle attached thereto.
